(19) United States
(12) Patent Application Publication
(10) Pub. No.: US 2004/0226950 A1
(43) Pub. Date: Nov. 18, 2004

(54) Integrally-formed cover for a container

(75) Inventors: John B. Samz, Union Grove, WI (US); William C. Vogel, Milwaukee, WI (US)

Correspondence Address: FOLEY & LARDNER, 777 EAST WISCONSIN AVENUE, SUITE 3800, MILWAUKEE, WI, 53202-5308, US

(73) Assignee: Gateway Plastics, Inc.

(21) Appl. No.: 10/435,653

(22) Filed: May 9, 2003

Related U.S. Application Data
(63) Continuation of application No. 10/234,441, filed on Sep. 3, 2002.
Application No. 10/234,441 is a division of application No. 09/663,874, filed on Sep. 15, 2000, now Pat. No. 6,460,718.
Application No. 09/663,874 is a continuation-in-part of application No. 09/374,976, filed on Aug. 16, 1999, now Pat. No. 6,250,517.
Application No. 09/374,976 is a continuation-in-part of application No. 08/959,399, filed on Oct. 28, 1997, now Pat. No. 5,971,231.

(51) Int. Cl. B65D 51/18; B67D 3/00

(52) U.S. Cl. 220/254.2; 220/254.3; 222/480; 222/565

(57) ABSTRACT

An integrally-formed cover for a container is disclosed. The integrally-formed cover comprises a cylindrical portion, a top portion, a shaker flap, a spooning flap, and an upwardly projecting lip. The top portion has a plurality of shaker openings and a spooning opening. The shaker flap and the spooning flap each have an outer edge with a downwardly extending skirt. The shaker flap and spooning flap are configured for selective movement between an open position and a closed position. The lip extends substantially around the shaker flap and the spooning flap and is configured to provide a guide for positioning a bottom of a container stacked on the top portion of the container cover. The cover may also comprise a sealing projection. The sealing projection may be circular and may be disposed inside the cylindrical portion. A container comprising a closed-bottom receptacle having an open and cylindrical upper end to which an integrally-formed cover is secured is also disclosed.

### CROSS REFERENCE TO RELATED APPLICATIONS

The present application is a continuation of U.S. application Ser. No. 10/234,441, filed Sep. 3, 2002, which is a divisional of U.S. application Ser. No. 09/663,874, filed Sep. 15, 2000, now U.S. Pat. No. 6,460,718, which is a continuation-in-part of U.S. application Ser. No. 09/374,976, filed Aug. 16, 1999, now U.S. Pat. No. 6,250,517, which is a continuation-in-part of U.S. application Ser. No. 08/959,399, filed Oct. 28, 1997, now U.S. Pat. No. 5,971,231.

The present application claims the benefit of priority as available under 35 U.S.C. §§ 120 and 121 of the following applications (which are incorporated by reference): U.S. application Ser. No. 10/234,441, filed Sep. 3, 2002, which is a divisional of U.S. application Ser. No. 09/663,874, filed Sep. 15, 2000, now U.S. Pat. No. 6,460,718, which is a continuation-in-part of U.S. application Ser. No. 09/374,976, filed Aug. 16, 1999, now U.S. Pat. No. 6,250,517, which is a continuation-in-part of U.S. application Ser. No. 08/959,399, filed Oct. 28, 1997, now U.S. Pat. No. 5,971,231.

### FIELD

The present inventions generally relate to a cover for a container for storing and dispensing matter.

### SUMMARY

The present invention relates to an integrally-formed cover for a container of a type including a receptacle having an open top and a closed bottom. The cover comprises a cylindrical portion, a top portion, a shaker flap, a spooning flap, and an upwardly projecting lip. The cylindrical portion is configured to be coupled to the receptacle. The top portion is formed integrally with the cylindrical portion and has a plurality of shaker openings and a spooning opening. The shaker flap is formed integrally with the top portion, has an outer edge with a downwardly extending skirt, is coupled to the top portion, and is configured for selective movement between an open position in which the shaker openings are opened and a closed position in which the shaker openings are closed. The spooning flap is formed integrally with the top portion, has an outer edge with a downwardly extending skirt, is coupled to the top portion, and is configured for selective movement between an open position in which the spooning opening is opened and a closed position in which the spooning opening is closed. The lip extends substantially around an outer portion of the shaker flap and an outer portion of the spooning flap and an outer portion of the top portion between the outer portion of the shaker flap and the outer portion of the spooning flap. The integrally-formed cover is configured to make contact with the top of the receptacle beneath the top portion of the cover when the cover is coupled to the receptacle.

The present invention also relates to an integrally-formed cover for a receptacle of a type having an open top and a closed bottom. The integrally-formed cover comprises a cylindrical portion, a top portion, a shaker flap, a spooning flap, and an upwardly projecting lip. The cylindrical portion is configured to be coupled to the top of the receptacle. The top portion has a plurality of shaker openings and a spooning opening. The shaker flap has an outer edge with a downwardly extending skirt, is coupled to the top portion, and is configured for selective movement between an open position in which the shaker openings are opened and a closed position in which the shaker openings are closed. The spooning flap has an outer edge with a downwardly extending skirt, is coupled to the top portion, and is configured for selective movement between an open position in which the spooning opening is opened and a closed position in which the spooning opening is closed. The lip extends substantially around an outer portion of the shaker flap and an outer portion of the spooning flap and an outer portion of the top portion between the outer portion of the shaker flap and the outer portion of the spooning flap so that a receptacle to be stacked on the top of the cover can be guided and positioned by the lip.

The present invention further relates to an integrally-formed cover for a food products container of a type including a receptacle with an open top and a closed bottom. The integrally-formed cover includes a cylindrical portion, a means for coupling the cover to a receptacle, a top portion, a shaker flap, and a spooning flap. The cylindrical portion has a first and a second end. The means for coupling the cover to a receptacle is disposed on an inner surface of the cylindrical portion. The top portion is substantially planar and circular and is coupled to and encloses the first end of the cylindrical portion. The top portion has a plurality of shaker openings disposed on a first side of the top portion and a spooning opening disposed on a second side of the top portion. The shaker flap is formed integrally with the top portion, has an outer edge with a downwardly extending skirt, is hingably secured to the top portion to open about a line parallel to a diametral line of the top portion, and is disposed to selectively cover and uncover the plurality of shaker openings. The spooning flap is formed integrally with the top portion, has an outer edge with a downwardly extending skirt, is hingably secured to the top portion to open about a line parallel to a diametral line of the top portion, and is disposed to selectively cover and uncover the spooning opening. The cylindrical portion has a first recess disposed to receive the skirt extending from the spooning flap and has a second recess disposed to receive the skirt extending from the shaker flap. The shaker flap and the spooning flap are recessed within the top portion and provide in combination with the outer edge a container supporting surface. The cover is configured so that the open top of the receptacle contacts the cover beneath the top portion when the cover is coupled to the receptacle.

### BRIEF DESCRIPTION OF THE DRAWINGS

FIG. 1 is a schematic representation of a cross-sectional side view of a container including a cover and receptacle.

FIG. 2 is a schematic representation of a perspective view of the cover of FIG. 1.

FIG. 3 is a schematic representation of a cross-sectional view of the container of FIG. 1.

FIG. 4 is a schematic representation of a top view of the cover of FIG. 1.

FIG. 5 is a schematic representation of a bottom view of the cover.

FIG. 6 is schematic representation of a partial plan view of the sealing ring of the cap (not to scale) with the rim of the receptacle.

FIG. 7 is a schematic representation of a partial cross-sectional side view of the sealing ring and receptacle rim.

FIG. 8 is a schematic representation of a partial plan view of the sealing ring of the cap (not to scale) with the rim of the receptacle.

FIG. 9 is a schematic representation of a partial cross-sectional side view of the sealing ring and receptacle rim.

FIGS. 10-12 are schematic representations of a fragmentary cross sectional views of the cover and receptacle shown in FIGS. 7 and 9.

FIG. 13 is a schematic representation of a cross-sectional side view of a container including a cover and receptacle.

FIG. 14 is a schematic representation of a perspective view of the cover of FIG. 13.

FIG. 15 is a schematic representation of a cross-sectional view of the container of FIG. 13.

FIG. 16 is a schematic representation of a top view of the cover of FIG. 13.

### DETAILED DESCRIPTION

It is to be understood that the inventions are not limited to the details of construction in the arrangement of the components set forth in the following description or illustrated in the drawings. The inventions are capable of other embodiments or of being practiced or carried out in various ways. It is also to be understood that the terminology employed in this application is for the purpose of description and should not be regarded as limiting.

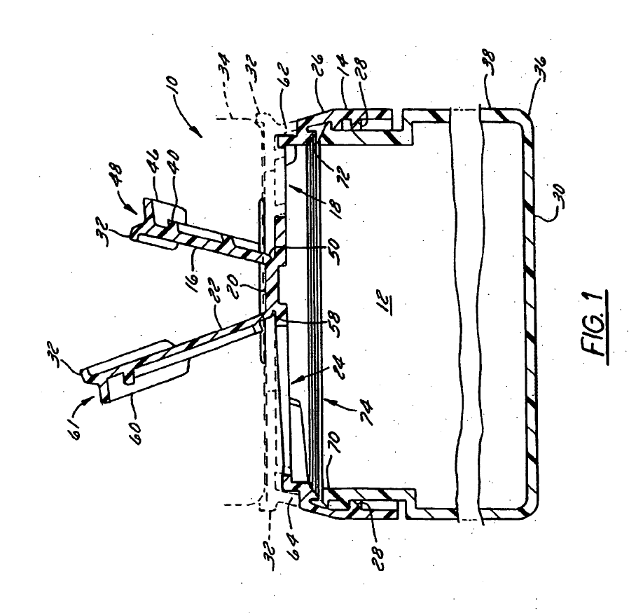

FIG. 1 illustrates a container 10 having a receptacle 12 and a cap or cover 14. As shown, cover 14 includes a shaker flap 16 that covers (when closed) shaker openings 18 disposed in planar top portion (or end) 20 of the cover. Cover 14 also includes a spooning flap 22 that similarly covers a larger spooning opening 24 also disposed in top portion 20.

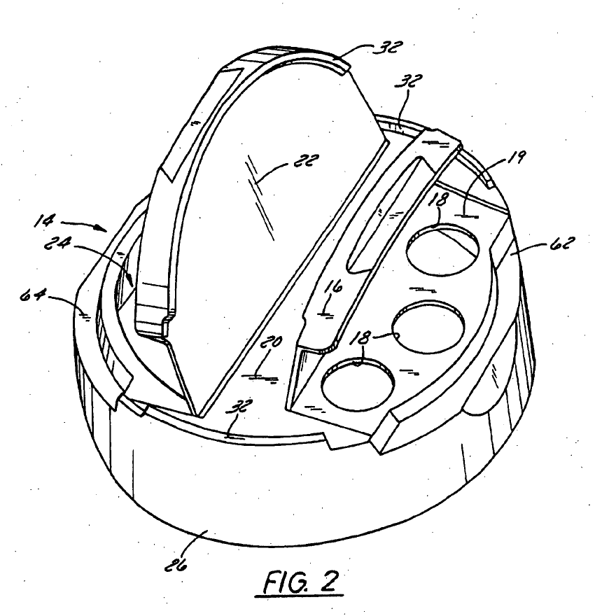

The cover (as shown in FIG. 2) is in the form of a substantially cylindrical portion 26, and top portion 20 which is coupled to an upper end of cylindrical portion 26 to cover cylindrical portion 26. As shown in FIG. 1, threads 28 are provided on the inner surface of cylindrical portion 26 for coupling cover 14 to the outside of the top of a receptacle 12. As shown in FIG. 1, mating threads are disposed on an outer indented top portion of receptacle 12 to engage threads 28. Alternatively, cylindrical portion 26 may be equipped with an inner detent or a raised ring to allow it to be snap connected to the top portion of receptacle 12. According to an exemplary embodiment as shown in FIG. 2, an elongate recess 19 is provided in which shaker flap 16 will fit when flap 16 is in a closed position, to provide a substantially flat upper surface of top portion 20 on which a similar container can be stacked.

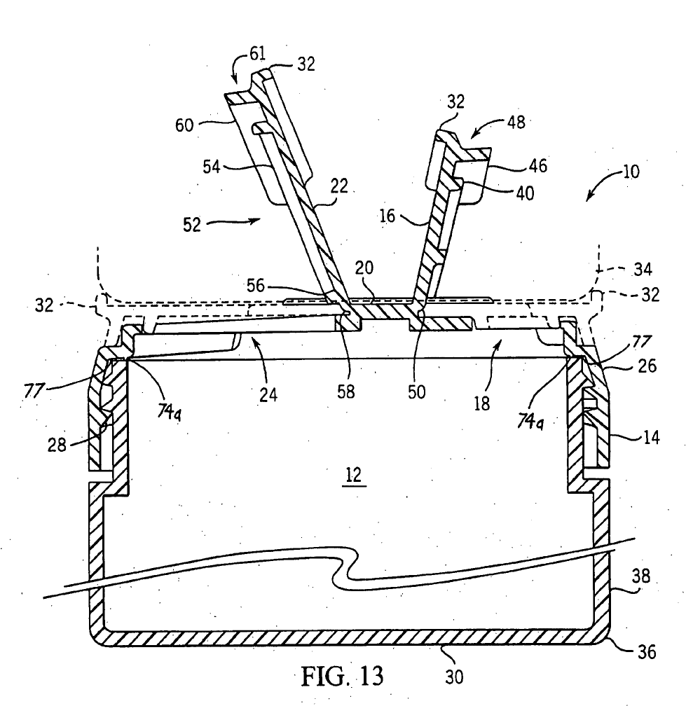

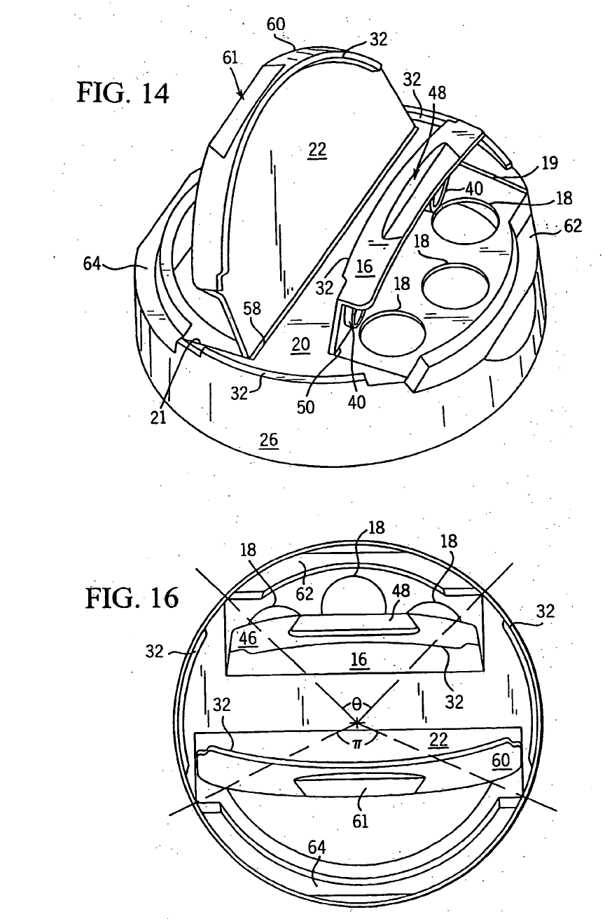

As shown in FIG. 1, receptacle 12 includes a substantially planar bottom portion 30 that is adapted to engage a lip 32 of cover 14. The bottom portion 30 is adapted to engage lip 32; a plurality of containers (see FIGS. 1 and 13) can be stacked one atop the other, lip 32 serving to orient the bottom of the next higher container and intended to keep the containers in proper alignment when stacked. In FIG. 1, two containers are shown (partially) in this stacked arrangement, the bottom of the upper container being shown as dashed line 34 engaging rim 32 when the flaps of the lower container are in a closed position (shown in FIG. 1 as dashed lines when in their closed positions). Bottom portion 30 of receptacle 12 (and hence bottom portion of container 34) and top portion 20 of cover 14 with lip 32 are adapted to engage one another. As shown in FIGS. 1, 3, and 13, lip 32 is disposed at an outer edge of cover 14 to engage a recess 36 at the junction of bottom 30 and wall 38 of receptacle 12. By disposing both lip 32 and recess 36 to engage each other near the outer periphery of the container, containers are more easily stacked (and when stacked tend to self-center). A portion of lip 32 is preferably disposed on shaker flap 16, spooning flap 22 and on the non-hinged sides of top portion 20 as shown in FIG. 4. Each of these portions is preferably disposed at an outer edge of cover 14 (and have substantially the same diameter).

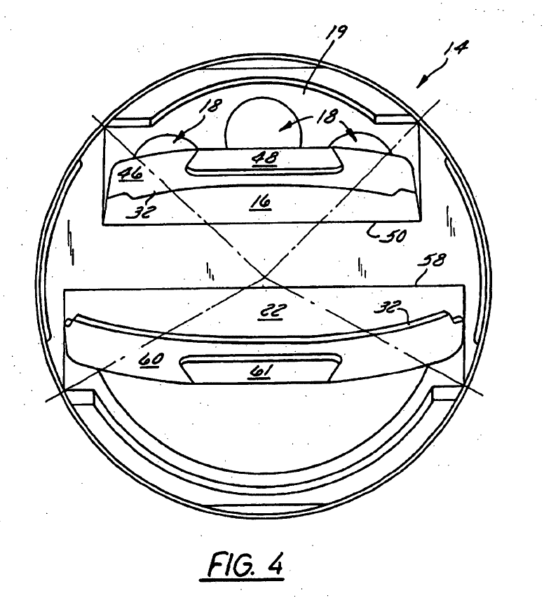

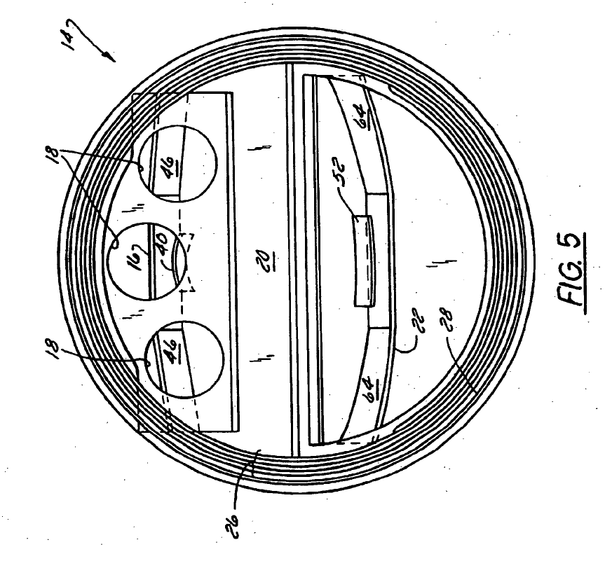

Referring to FIGS. 1 and 2, a plurality of shaker openings 18 (preferably substantially circular as shown) are provided to allow foodstuffs within the container to be shaken out when shaker flap 16 is opened. Openings 18 are (preferably) shown arranged along an arc (as shown in FIG. 2). On the underside of shaker flap 16 is an arcuate flange 40 adapted to engage and seal central shaker opening 18 which extends for about 30 degrees around the periphery of its mating opening 18 when in a closed position (as shown in FIG. 5). Flange 40 engages the inner surface of opening 18 and holds the shaker flap closed.

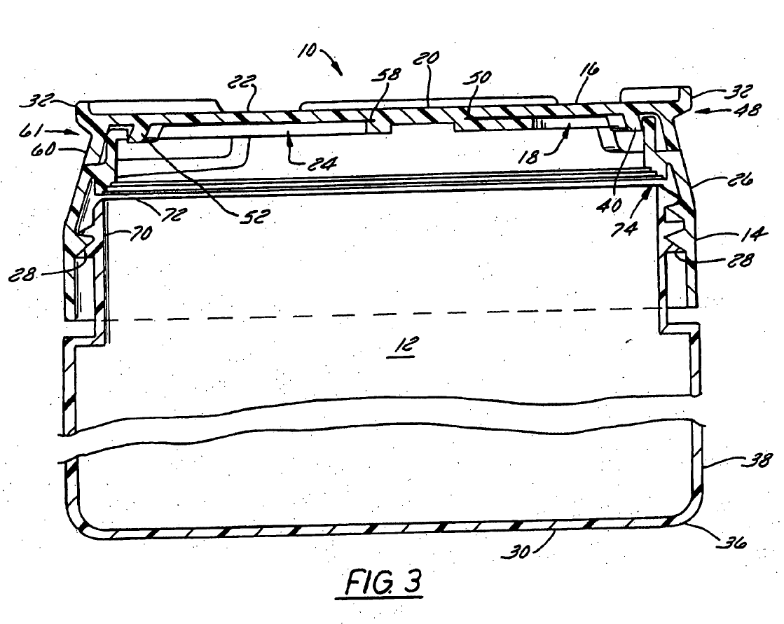

FIG. 3 shows cover 14 in cross-section along a diametral line of the cover. The cross section is shown perpendicular to both the shaker flap hinge 50 and the spooning flap hinge 58. Flange 40 extends, downward from the underside of shaker flap 16 (and outward) at an angle of between 9 and 25 degrees (preferably of between 5 and 20 degrees) with respect to the longitudinal axis of container 10. This angular relationship allows the cover, including the flaps, to be readily and integrally molded as a single monolithic piece (in the orientation shown generally in FIGS. 1 and 13, e.g. with flaps as depicted at approximately 15 to 20 degrees from vertical). In addition, this angle allows flange 40 to releasably lock into central opening 18 when shaker flap 16 is closed.

Shaker flap 16 also includes a skirt 46 that extends downwardly from shaker flap 16. Skirt 46 is disposed at an outer edge of shaker flap 16. Skirt 46 is shown as indented into the cap to provide (together with the outer surface of cylindrical portion 26), a substantially right circular cylindrical wall.

Skirt 46 has an indentation 48 shown as disposed at a central outer portion of skirt 46 and is configured to receive a finger or finger nail of the user to allow the user to grasp shaker flap 16 at the indentation and readily open container 10 by lifting upward.

Skirt 46 preferably extends around cover 14 for an arcuate length of between 60 and 120 degrees (see FIG. 4). According to an exemplary embodiment shown in FIG. 4, skirt 46 forms between 60 and 120 degrees of the circumference of the upper part of cover 14. Skirt 46 is arcuate (rather than straight) to distribute the grasping load more evenly around the outer edge of shaker flap 16 and is less likely to be bent when the cover is grasped and opened. The arcuate configuration of skirt 46 allows shaker flap 16 to be made thinner and therefore to require less plastic when manufactured.

Referring to FIG. 3, when the shaker flap 16 is closed, flange 40 engages an outer portion of shaker opening 18 to releasably lock shaker flap 16 to top portion 20 in a closed position. While only a single flange 40 is shown in cross section in FIG. 3, each of the other openings 18 may also have a flange (not shown) to provide additional engagement surfaces for holding the shaker flap closed.

As shown schematically in FIG. 4, shaker flap 16 is coupled to top portion 20 by a flexible and integrally formed hinge 50 preferably extending the entire length of shaker flap 16.

As shown schematically in FIG. 4, spooning flap 22 is coupled to top portion 20 by a flexible and integrally formed hinge 58 preferably extending the entire length of spooning flap 22. Hinges 50 and 58 are disposed adjacent to a diametral line of cover 14 to allow the flaps to hinge upward and toward the middle of cover 14.

According to an exemplary embodiment shown in FIG. 3, spooning flap 22 covers spooning opening 24. Spooning flap 22 has a flange 52 depending from a lower surface of spooning flap 22 that engages and locks against the inside of opening 24. Flange 52 extends at an angle (preferably between 9 and 25 degrees) outward and downward from the underside of spooning flap 22.

As with flange 40 of the shaker flap, by disposing flange 52 at an angle, cover 14 can be manufactured in a single piece with spooning flap 22 formed integrally with cover 14. Flange 52 preferably has an arcuate length of between 20 and 180 degrees (shown as approximately 20 degrees). Over this length, flange 52 is intended to engage the inside edge of spooning opening 24 to releasably lock spooning flap 22 to top portion 20 when spooning flap 22 is in a closed position.

As shown schematically in FIGS. 1 and 3, spooning flap 22 includes a skirt 60 (like skirt 46 of shaker flap 16). Skirt 60 is shown extending downwardly from spooning flap 22 near an outer edge of spooning flap 22 and has an arcuate shape to define an outer substantially vertical surface of cover 14 when spooning flap 22 is in a closed position. Skirt 60 has an indentation 61 shown disposed at a central outer portion of skirt 60 and configured to receive a finger or fingernail of the user to allow the user to grasp spooning flap 22 at the indentation and readily open container 10. Skirt 60 preferably extends around the circumference of cover 14 when in the closed position for an angle pi of between 100 and 150 degrees (see FIG. 4). Skirt 60 is arcuate (rather than straight) to distribute the grasping load more evenly around the outer edge of spooning flap 22 and is less likely to be bent when the cover is grasped and opened. The arcuate configuration of skirt 60 allows spooning flap 22 to be made thinner and therefore to require less plastic when manufactured. According to an exemplary embodiment shown in FIG. 4, the arcuate length of skirt 60 is greater than the arcuate length of skirt 46 and therefore provides additional strength to spooning flap 22.

A recess 62 (shown in FIG. 2) is provided in the cylindrical portion of cover 14 to receive skirt 46 of shaker flap 16, so that skirt 46 can be set into an outer surface of cover 14 when shaker flap is closed, to reduce the risk that skirt 46 will be accidentally jostled and caught, shaker flap 16 opened and the contents of container 10 spilled; a recess 64 is provided on the opposite side of cover 14 from recess 62 to receive skirt 60 of spooning flap 22. Skirts 46 and 60 form a smooth and contiguous part of the outer surface of the cylindrical portion of cover 14.

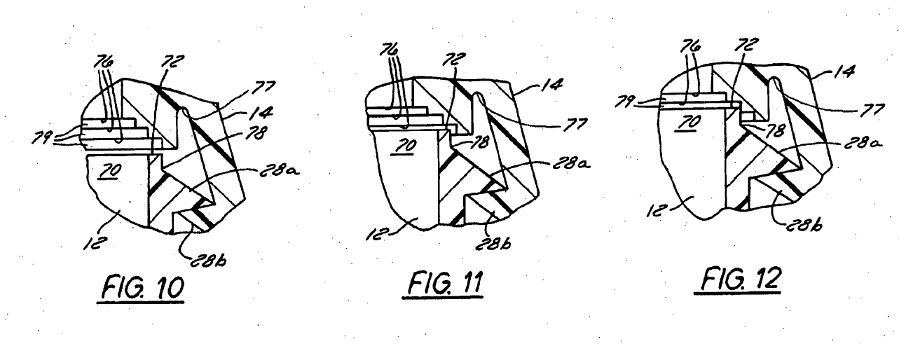

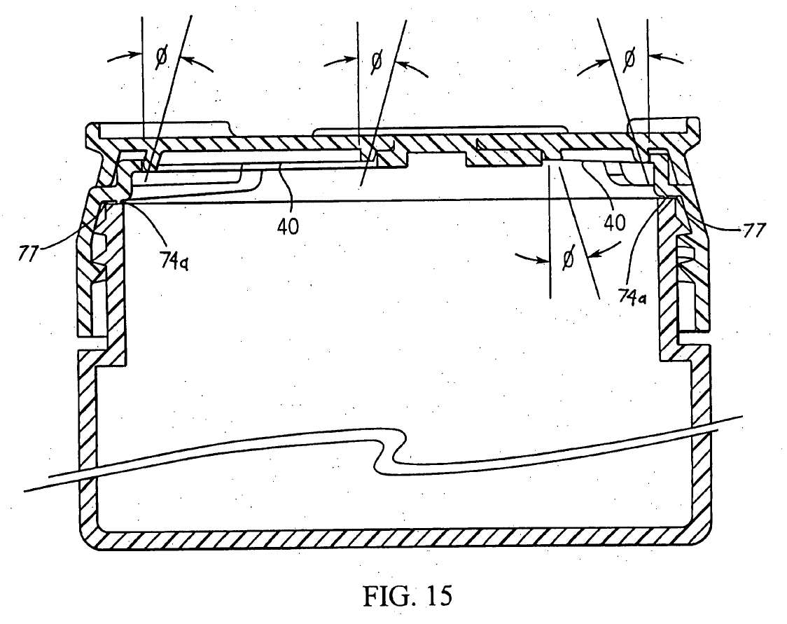

As shown schematically in FIGS. 1 and 3, rim 70 of receptacle 12 has an upper sealing surface 72 that abuts a projection (shown as sealing ring 74) of the cover when the cover is screwed onto the receptacle. According to an exemplary embodiment shown in FIGS. 10 through 12, sealing ring 74 is spaced apart from cylindrical portion 26 of cover 14 to form a gap 77. According to an exemplary embodiment shown in FIGS. 13 and 15, a sealing projection 74a provides a sealing surface that extends from the underside of top portion 20 of cover 14 (within cylindrical portion 26 to provide a gap 77).

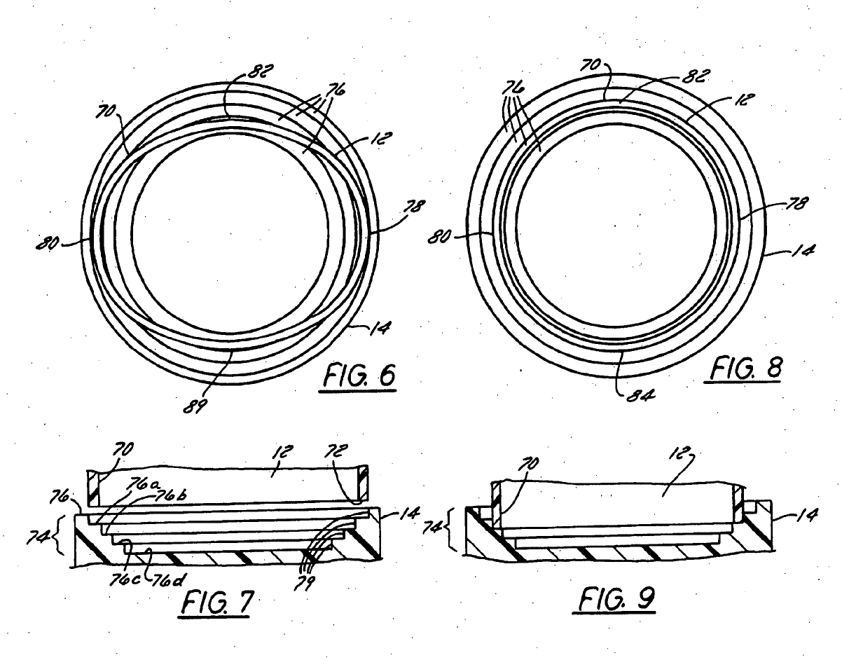

As shown in FIGS. 1, 3 and 5 through 12, sealing ring 74 has several separate and distinct sealing surfaces 76; surfaces 76 are flat and separated from adjacent sealing surfaces by cylindrical walls 79 (shown as circular and parallel to the longitudinal axis of the cap so that sealing surfaces 76 are arranged in a “stair step” fashion, see FIG. 7). Each sealing surface defines a plane that is substantially perpendicular to the longitudinal axis of the receptacle and cover. As shown schematically in FIGS. 6 and 7, a “warped” bottle with an oval rim 70 and sealing surface 72 may be screwed into cover 14.

FIGS. 10-12 show (schematically) a receptacle rim 70 as it approaches sealing surface 76 of cover 14 (as the cover and receptacle are rotated with respect to each other).

As shown in FIGS. 7 and 9, there are four sealing surfaces 76a and 76b and 76c and 76d on cover 14 (each having a slightly smaller diameter) so that cover 14 may be attached to receptacles with different rim diameters (e.g. receptacles with a smaller rim diameter will rest on sealing surfaces that also have smaller diameters and receptacles with a larger diameter will nest on sealing surfaces with larger diameters).

According to alternative embodiments, the arrangement of the cover is intended to accommodate a receptacle having variety of mouth sizes by providing several sealing surfaces against which the mouth of the receptacles can seal and/or to correct the shape of warped bottles (e.g., used with automatic capping machines).

The present inventions are intended to embrace all alternatives, modifications and variations that fall within the spirit and broad scope of the claims.

What is claimed is:

31. An integrally-formed cover for a container of a type including a receptacle having an open top and a closed bottom comprising:
a cylindrical portion configured to be coupled to the receptacle;
a top portion formed integrally with the cylindrical portion having a plurality of shaker openings and a spooning opening;
a shaker flap formed integrally with the top portion having an outer edge with a downwardly extending skirt and coupled to the top portion and configured for selective movement between an open position in which the shaker openings are opened and a closed position in which the shaker openings are closed;
a spooning flap formed integrally with the top portion having an outer edge with a downwardly extending skirt and coupled to the top portion and configured for selective movement between an open position in which the spooning opening is opened and a closed position in which the spooning opening is closed; and
an upwardly projecting lip formed integrally with and extending substantially around an outer portion of the shaker flap and an outer portion of the spooning flap and an outer portion of the top portion between the outer portion of the shaker flap and the outer portion of the spooning flap, whereby the lip provides a guide for positioning the closed bottom of a container stacked on top of the integrally-formed cover;
wherein the integrally-formed cover is configured to make contact with the top of the receptacle beneath the top portion of the cover when the cover is coupled to the receptacle.

32. The integrally-formed cover of claim 31 further comprising a sealing projection projecting beneath the top portion of the cover to make contact with the top of the receptacle.

33. The integrally-formed cover of claim 32 wherein the sealing projection is a sealing ring.

34. The integrally-formed cover of claim 33 wherein the sealing ring is disposed inside the cylindrical portion.

35. The integrally-formed cover of claim 34 wherein the sealing ring and the cylindrical portion are separated by a gap.

36. The integrally-formed cover of claim 35 wherein the sealing ring comprises a plurality of sealing surfaces.

37. The integrally-formed cover of claim 36 wherein the plurality of sealing surfaces are stepped.

38. The integrally-formed cover of claim 36 wherein one of the sealing surfaces is at a first elevation and another of the sealing surfaces is at a second elevation.

39. The integrally-formed cover of claim 31 wherein the upwardly projecting lip on the outer portion of the shaker flap projects from the shaker flap in an opposite direction from the downwardly extending skirt of the shaker flap.

40. The integrally-formed cover of claim 31 wherein the upwardly projecting lip on the outer portion of the spooning flap projects from the spooning flap in an opposite direction from the downwardly extending skirt of the spooning flap.

41. The integrally-formed cover of claim 31 wherein the shaker flap is coupled to the top portion to open about a line adjacent to a diametral line of the top portion.

42. The integrally-formed cover of claim 41 wherein the line about which the shaker flap opens is parallel to the diametral line of the top portion.

43. The integrally-formed cover of claim 31 wherein the spooning flap is coupled to the top portion to open about a line adjacent to a diametral line of the top portion.

44. The integrally-formed cover of claim 43 wherein the line about which the spooning flap opens is parallel to the diametral line of the top portion.

45. The integrally-formed cover of claim 31 wherein the shaker flap has a pair of substantially parallel side edges.

46. The integrally-formed cover of claim 31 wherein the spooning flap has a pair of substantially parallel side edges.

47. The integrally-formed cover of claim 31 wherein the outer edge of the shaker flap and the downwardly extending skirt of the shaker flap extend around the cover for an angle of between 60 and 120 degrees.

48. The integrally-formed cover of claim 31 wherein the outer edge of the spooning flap and the downwardly extending skirt of the spooning flap extend around the cover for an angle of between 100 and 150 degrees.

49. The integrally-formed cover of claim 36 wherein each sealing surface has a width substantially equal to or less than an average thickness of the cap.

50. The integrally-formed cover of claim 49 wherein the sealing ring comprises a plurality of stepped sealing surfaces.

51. The integrally-formed cover of claim 50 wherein each of the plurality of stepped sealing surfaces is coaxial with the cylindrical portion.

52. The integrally-formed cover of claim 31 wherein a lip is provided on the outer portion of the shaker flap, a lip is provided on the outer portion of the spooning flap, and a lip is provided on an outer portion of the top portion between the outer portion of the shaker flap and the outer portion of the spooning flap.

53. The integrally-formed cover of claim 31 wherein the cylindrical portion comprises a first recess configured to receive the skirt extending from the spooning flap and a second recess configured to receive the skirt extending from the shaker flap, wherein the skirt extending from the spooning flap and the skirt extending from the shaker flap form a smooth and contiguous part of the cylindrical portion when the spooning flap and the shaker flap are in the closed position.

54. The integrally-formed cover of claim 31 wherein the downwardly extending skirt of the shaker flap and the downwardly extending skirt of the spooning flap each comprise an indention along a central outer portion of the skirt that is configured to receive a finger of a user.

55. The integrally-formed cover of claim 31 wherein the downwardly extending skirt of the shaker flap extends both downward with respect to the shaker flap and outward with respect to a central axis of the cover when the shaker flap is in the closed position.

56. The integrally-formed cover of claim 55 wherein the downwardly extending skirt of the shaker flap extends at an angle of between 9 and 25 degrees with respect to the central axis of the cover.

57. The integrally-formed cover of claim 31 wherein the downwardly extending skirt of the spooning flap extends both downward with respect to the spooning flap and outward with respect to a central axis of the cover when the spooning flap is in the closed position.

58. The integrally-formed cover of claim 57 wherein the downwardly extending skirt of the spooning flap extends at an angle of between 9 and 25 degrees with respect to the central axis of the cover.

59. The integrally-formed cover of claim 31 wherein the upwardly projecting lip of the shaker flap and the upwardly projecting lip of the spooning flap have an outer diameter substantially the same as the outer diameter of the cylindrical portion.

60. The integrally-formed cover of claim 31 wherein the top portion includes an upwardly projecting lip at an edge of the top portion adjacent to the cylindrical portion.

61. The integrally-formed cover of claim 60 wherein the upwardly projecting lip of the top portion has substantially the same diameter as the upwardly projecting lip of the shaker flap and the upwardly projecting lip of the spooning flap.

62. The integrally-formed cover of claim 33 wherein the sealing ring projects from the top portion.

63. The integrally-formed cover of claim 62 wherein the sealing ring is inside of the cylindrical portion.

64. An integrally-formed cover for a receptacle of a type having an open top and a closed bottom comprising:
a cylindrical portion configured to be coupled to the top of the receptacle;
a top portion having a plurality of shaker openings and a spooning opening;
a shaker flap having an outer edge with a downwardly extending skirt and coupled to the top portion and configured for selective movement between an open position in which the shaker openings are opened and a closed position in which the shaker openings are closed;
a spooning flap having an outer edge with a downwardly extending skirt and coupled to the top portion and configured for selective movement between an open position in which the spooning opening is opened and a closed position in which the spooning opening is closed; and
an upwardly projecting lip extending substantially around an outer portion of the shaker flap and an outer portion of the spooning flap and an outer portion of the top portion between the outer portion of the shaker flap and the outer portion of the spooning flap;
so that a receptacle to be stacked on the top of the cover can be guided and positioned by the lip.

65. The integrally-formed cover of claim 64 further comprising a sealing ring disposed inside the cover.

66. The integrally-formed cover of claim 65 wherein the sealing ring is circular.

67. The integrally-formed cover of claim 66 wherein the sealing ring is disposed inside the cylindrical portion.

68. The integrally-formed cover of claim 67 wherein the sealing ring comprises a plurality of sealing surfaces.

69. The integrally-formed cover of claim 68 wherein the plurality of sealing surfaces are stepped.

70. The integrally-formed cover of claim 64 wherein the upwardly projecting lip on the outer portion of the shaker flap projects from the shaker flap in an opposite direction from the downwardly extending skirt of the shaker flap.

71. The integrally-formed cover of claim 64 wherein the upwardly projecting lip on the outer portion of the spooning flap projects from the spooning flap in an opposite direction from the downwardly extending skirt of the spooning flap.

72. The integrally-formed cover of claim 64 wherein the shaker flap is coupled to the top portion to open about a line adjacent to a diametral line of the top portion.

73. The integrally-formed cover of claim 72 wherein the line about which the shaker flap opens is parallel to the diametral line of the top portion.

74. The integrally-formed cover of claim 64 wherein the spooning flap is coupled to the top portion to open about a line adjacent to a diametral line of the top portion.

75. The integrally-formed cover of claim 74 wherein the line about which the spooning flap opens is parallel to the diametral line of the top portion

76. The integrally-formed cover of claim 64 wherein the shaker flap has a pair of substantially parallel side edges.

77. The integrally-formed cover of claim 64 wherein the spooning flap has a pair of substantially parallel side edges.

78. The integrally-formed cover of claim 64 wherein the outer edge of the shaker flap and the downwardly extending skirt of the shaker flap extend around the cover for an angle of between 60 and 120 degrees.

79. The integrally-formed cover of claim 64 wherein the outer edge of the spooning flap and the downwardly extending skirt of the spooning flap extend around the cover for an angle of between 100 and 150 degrees.

80. The integrally-formed cover of claim 68 wherein each sealing surface has a width substantially equal to or less than an average thickness of the cap.

81. The integrally-formed cover of claim 80 wherein the sealing ring comprises a plurality of stepped sealing surfaces.

82. The integrally-formed cover of claim 81 wherein each of the plurality of stepped sealing surfaces is coaxial with the cylindrical portion.

83. The integrally-formed cover of claim 64 wherein a lip is provided on an outer portion of the top portion between the outer portion of the shaker flap and the outer portion of the spooning flap.

84. The integrally-formed cover of claim 64 wherein the cylindrical portion comprises a first recess configured to receive the skirt extending from the spooning flap and a second recess configured to receive the skirt extending from the shaker flap, wherein the skirt extending from the spooning flap and the skirt extending from the shaker flap form a smooth and contiguous part of the cylindrical portion when the spooning flap and the shaker flap are in the closed position.

85. The integrally-formed cover of claim 64 wherein the downwardly extending skirt of the shaker flap and the downwardly extending skirt of the spooning flap each comprise an indention along a central outer portion of the skirt that is configured to receive a finger of a user.

86. The integrally-formed cover of claim 64 wherein the downwardly extending skirt of the shaker flap extends both downward with respect to the shaker flap and outward with respect to a central axis of the cover when the shaker flap is in the closed position.

87. The integrally-formed cover of claim 86 wherein the downwardly extending skirt of the shaker flap extends at an angle of between 9 and 25 degrees with respect to the central axis of the cover.

88. The integrally-formed cover of claim 64 wherein the downwardly extending skirt of the spooning flap extends both downward with respect to the spooning flap and outward with respect to a central axis of the cover when the spooning flap is in the closed position.

89. The integrally-formed cover of claim 88 wherein the downwardly extending skirt of the spooning flap extends at an angle of between 9 and 25 degrees with respect to the central axis of the cover.

90. The integrally-formed cover of claim 64 wherein the upwardly projecting lip of the shaker flap and the upwardly projecting lip of the spooning flap have an outer diameter substantially the same as the outer diameter of the cylindrical portion.

91. The integrally-formed cover of claim 64 wherein the top portion includes an upwardly projecting lip at an edge of the top portion adjacent to the cylindrical portion.

92. The integrally-formed cover of claim 91 wherein the upwardly projecting lip of the top portion has substantially the same diameter as the upwardly projecting lip of the shaker flap and the upwardly projecting lip of the spooning flap.

93. The integrally-formed cover of claim 65 wherein the sealing ring projects beneath the top portion.

94. The integrally-formed cover of claim 93 wherein the sealing ring is inside of the cylindrical portion.

95. An integrally-formed cover for a receptacle of a type having an open top and a closed bottom comprising:
a generally cylindrical portion;
a top portion having a plurality of shaker openings and a spooning opening;
a shaker flap having an outer edge with a downwardly extending skirt and coupled to the top portion and configured for selective movement between an open position in which the shaker openings are opened and a closed position in which the shaker openings are closed;
a spooning flap having an outer edge with a downwardly extending skirt and coupled to the top portion and configured for selective movement between an open position in which the spooning opening is opened and a closed position in which the spooning opening is closed;
an upwardly projecting rim extending substantially around an outer portion of the shaker flap and an outer portion of the spooning flap;
a sealing projection disposed within the cylindrical portion and below the top portion and configured to contact the top of the receptacle on which the cover is attached; and
wherein the rim is configured to provide a guide for positioning the bottom of a receptacle stacked on the top portion of the cover.

96. The integrally-formed cover of claim 95 wherein the rim extends at least partially around an outer portion of the top portion between the outer portion of the shaker flap and the outer portion of the spooning flap.

97. The integrally-formed cover of claim 95 wherein the sealing projection is a sealing ring.

98. The integrally-formed cover of claim 97 wherein the sealing ring is disposed inside the cylindrical portion.

99. The integrally-formed cover of claim 98 wherein the sealing ring and the cylindrical portion are separated by a gap.

100. The integrally-formed cover of claim 99 wherein the sealing ring comprises a plurality of sealing surfaces.

101. The integrally-formed cover of claim 100 wherein the plurality of sealing surfaces are stepped.

102. The integrally-formed cover of claim 101 wherein one of the sealing surfaces is at a first elevation and another of the sealing surfaces is at a second elevation.

103. The integrally-formed cover of claim 95 wherein the upwardly projecting rim on the outer portion of the shaker flap projects from the shaker flap in an opposite direction from the downwardly extending skirt of the shaker flap.

104. The integrally-formed cover of claim 95 wherein the upwardly projecting rim on the outer portion of the spooning flap projects from the spooning flap in an opposite direction from the downwardly extending skirt of the spooning flap.

105. The integrally-formed cover of claim 95 wherein the shaker flap is coupled to the top portion to open about a line adjacent to a diametral line of the top portion.

106. The integrally-formed cover of claim 105 wherein the line about which the shaker flap opens is parallel to the diametral line of the top portion.

107. The integrally-formed cover of claim 95 wherein the spooning flap is coupled to the top portion to open about a line adjacent to a diametral line of the top portion.

108. The integrally-formed cover of claim 107 wherein the line about which the spooning flap opens is parallel to the diametral line of the top portion.

109. The integrally-formed cover of claim 95 wherein the shaker flap has a pair of substantially parallel side edges.

110. The integrally-formed cover of claim 95 wherein the spooning flap has a pair of substantially parallel side edges.

111. The integrally-formed cover of claim 95 wherein the outer edge of the shaker flap and the downwardly extending skirt of the shaker flap extend around the cover for an angle of between 60 and 120 degrees.

112. The integrally-formed cover of claim 95 wherein the outer edge of the spooning flap and the downwardly extending skirt of the spooning flap extend around the cover for an angle of between 100 and 150 degrees.

113. The integrally-formed cover of claim 100 wherein each sealing surface has a width substantially equal to or less than an average thickness of the cap.

114. The integrally-formed cover of claim 113 wherein the sealing ring comprises a plurality of stepped sealing surfaces.

115. The integrally-formed cover of claim 114 wherein each of the plurality of stepped sealing surfaces is coaxial with the cylindrical portion.

116. The integrally-formed cover of claim 95 wherein the cylindrical portion comprises a first recess configured to receive the skirt extending from the spooning flap and a second recess configured to receive the skirt extending from the shaker flap, wherein the skirt extending from the spooning flap and the skirt extending from the shaker flap form a smooth and contiguous part of the cylindrical portion when the spooning flap and the shaker flap are in the closed position.

117. The integrally-formed cover of claim 95 wherein the downwardly extending skirt of the shaker flap and the downwardly extending skirt of the spooning flap each comprise an indention along a central outer portion of the skirt that is configured to receive a finger of a user.

118. The integrally-formed cover of claim 95 wherein the downwardly extending skirt of the shaker flap extends both downward with respect to the shaker flap and outward with respect to a central axis of the cover when the shaker flap is in the closed position.

119. The integrally-formed cover of claim 118 wherein the downwardly extending skirt of the shaker flap extends at an angle of between 9 and 25 degrees with respect to the central axis of the cover.

120. The integrally-formed cover of claim 95 wherein the downwardly extending skirt of the spooning flap extends both downward with respect to the spooning flap and outward with respect to a central axis of the cover when the spooning flap is in the closed position.

121. The integrally-formed cover of claim 120 wherein the downwardly extending skirt of the spooning flap extends at an angle of between 9 and 25 degrees with respect to the central axis of the cover.

122. The integrally-formed cover of claim 95 wherein the upwardly projecting rim of the shaker flap and the upwardly projecting rim of the spooning flap have an outer diameter substantially the same as the outer diameter of the cylindrical portion.

123. The integrally-formed cover of claim 95 wherein the top portion includes an upwardly projecting rim at an edge of the top portion adjacent to the cylindrical portion.

124. The integrally-formed cover of claim 123 wherein the upwardly projecting rim of the top portion has substantially the same diameter as the upwardly projecting rim of the shaker flap and the upwardly projecting rim of the spooning flap.

125. The integrally-formed cover of claim 97 wherein the sealing ring projects beneath the top portion.

126. The integrally-formed cover of claim 125 wherein the sealing ring is inside of the cylindrical portion.

127. An integrally-formed cover for a receptacle of a type having an open top and a closed bottom comprising:
a cylindrical portion;
a top portion having a plurality of shaker openings and a spooning opening;
a shaker flap having an outer edge with a downwardly extending skirt and coupled to the top portion and configured for selective movement between an open position in which the shaker openings are opened and a closed position in which the shaker openings are closed;
a spooning flap having an outer edge with a downwardly extending skirt and coupled to the top portion and configured for selective movement between an open position in which the spooning opening is opened and a closed position in which the spooning opening is closed; and
an upwardly projecting rim extending substantially around an outer portion of the shaker flap and an outer portion of the spooning flap and an outer portion of the top portion between the outer portion of the shaker flap and the outer portion of the spooning flap, whereby the rim provides a guide for positioning the closed bottom of a receptacle stacked on top of the integrally-formed cover;
wherein the integrally-formed cover is configured so that the open top of the receptacle contacts the integrally-formed cover beneath the top portion when the integrally-formed cover is coupled to the receptacle.

128. The integrally-formed cover of claim 127 further comprising a sealing projection disposed within the cylindrical portion to make contact with the open top of the receptacle.

129. The integrally-formed cover of claim 128 wherein the sealing projection and the cylindrical portion are separated by a gap.

130. The integrally-formed cover of claim 127 wherein the shaker flap has a pair of substantially parallel side edges.

131. The integrally-formed cover of claim 127 wherein the spooning flap has a pair of substantially parallel side edges.

132. The integrally-formed cover of claim 127 wherein the cylindrical portion comprises a first recess configured to receive the skirt extending from the spooning flap and a second recess configured to receive the skirt extending from the shaker flap, wherein the skirt extending from the spooning flap and the skirt extending from the shaker flap form a contiguous part of the cylindrical portion when the spooning flap and the shaker flap are in the closed position.

133. An integrally-formed cover for a food products container of a type including a receptacle with an open top and a closed bottom comprising:
a cylindrical portion having a first and a second end;
a means for coupling the cover to a receptacle disposed on an inner surface of the cylindrical portion;
a substantially planar and circular top portion coupled to and enclosing the first end of the cylindrical portion and having a plurality of shaker openings disposed on a first side of the top portion and a spooning opening disposed on a second side of the top portion;
a shaker flap formed integrally with the top portion and having an outer edge with a downwardly extending skirt and hingably secured to the top portion to open about a line parallel to a diametral line of the top portion and disposed to selectively cover and uncover the plurality of shaker openings; and
a spooning flap formed integrally with the top portion and having an outer edge with a downwardly extending skirt and hingably secured to the top portion to open about a line parallel to a diametral line of the top portion and disposed to selectively cover and uncover the spooning opening;
wherein the cylindrical portion has a first recess disposed to receive the skirt extending from the spooning flap;
wherein the cylindrical portion has a second recess disposed to receive the skirt extending from the shaker flap;
wherein the shaker flap and the spooning flap are recessed within the top portion, and provide in combination with the outer edge a container supporting surface; and
wherein the cover is configured so that the open top of the receptacle contacts the cover beneath the top portion when the cover is coupled to the receptacle.

134. The cover of claim 133 further comprising an upwardly projecting lip extending substantially around the outer edge of the shaker flap and the outer edge of the spooning flap, whereby the lip provides a guide for positioning the closed bottom of a container stacked on top of the cover.

135. The cover of claim 133 further comprising a sealing projection projecting beneath the top portion to make contact with the open top of the receptacle.

136. The cover of claim 135 wherein the sealing projection is a sealing ring.

137. The cover of claim 136 wherein the sealing ring comprises a plurality of sealing surfaces.

138. The cover of claim 137 wherein the plurality of sealing surfaces are stepped.

139. The cover of claim 133 wherein the downwardly extending skirt of the shaker flap extends both downward with respect to the shaker flap and outward with respect to a central axis of the cover when the shaker flap is covering the plurality of shaker openings.

140. The cover of claim 133 wherein the downwardly extending skirt of the spooning flap extends both downward with respect to the spooning flap and outward with respect to a central axis of the cover when the spooning flap is covering the spooning opening.
